(19) United States
(12) Patent Application Publication
(10) Pub. No.: US 2014/0032289 A1
(43) Pub. Date: Jan. 30, 2014

(54) MEANS OF AMASSING THIRD-PARTY CONTACT INFORMATION FROM DIRECT MARKETING MEMBERS

(71) Applicant: Mitch HUHEM, San Diego, CA (US)

(72) Inventor: Mitch HUHEM, San Diego, CA (US)

(21) Appl. No.: 13/556,203

(22) Filed: Jul. 24, 2012

(51) Int. Cl. G06Q 10/00; G06Q 30/00

(52) U.S. Cl. 705/14.16

(57) ABSTRACT

A method and computer program product are disclosed for amassing contact information of DS prospects commonly acquainted with an DS member. The method requires a DS member to provide a list of contacts, those contacts are solicited by a DS employee, and the DS member is compensated for revenue generated from contacts joining the DS company. Unique multimedia presentations are shown to each contact who responds to electronic solicitation from the DS company, which presentations are personalized for the contacts. In some embodiments, prospects in the list are assigned value identifiers and into a hierarchal direct sales (DS) structure for solicitation by DS personal trained to commence cold contact with third-party prospects to build a commission downline for current the member with whom the prospects are commonly acquainted. Unique standardized valuation identifiers are generated by the disclosed method and computer program product for estimating commercial viability of each DS prospect.

### BACKGROUND OF THE INVENTION

1. Field of the Invention

This invention relates to direct sales, and more particularly relates to a method of gathering information relevant to soliciting new members into a hierarchical direct sales business structure.

2. Description of the Related Art

Direct sales (DS) business structures assume responsibility for the sale of select consumer products, services, and/or opportunities to both revenue-sharing members of the direct sales structure and third-parties. Direct sales structures reward members who successfully recruit and retain new members within the structure by remitting commissions to the recruiting members in accordance with a predetermined commission criteria adopted by the direct sales structure (also known as a multilevel marketing structure). Companies adopting, or assuming, an DS structure motivate their members with the commission criteria to profit not just from the sale of DS goods to others, but also from sales effectuated by newer members brought into the DS structure by older members.

DS structures necessarily organize their members into hierarchical pay grades, tiers, or levels, and distribute commissions made on the sale of consumer products by trickling the commissions up to members in higher levels who were responsible for bringing subsequent members into the DS structure in lower tier levels.

In accordance with their business objectives, DS structures will often provide their members with printed instructions and/or training in effective methods of both selling consumer products and recruiting others into the DS structure. Typical methods of recruiting others include conferences in which potential members, or contacts of members, are given the opportunity to socialize with experienced members, experience multimedia presentations of various species, hear testimonials of successful members, and become acquainted with the particular implementation of the DS structure assumed by the company or organization offering the one or more consumer product(s) underlying the DS structure.

Many companies implementing DS structures have enjoyed remarkable success, but other DS companies have struggled due to the inability and/or reluctance of many members, and potential members, to participate in the DS marketing programs. Many members and potential members are hesitant to recruit their personal and professional contacts into the DS structure. Members may lack the ability to successfully recruit their contacts, or may be disinclined to strain relationships they have established with their contacts by subjecting those contacts to the rhetoric necessary to successfully recruit them. These members may be similarly disinclined to solicit sales of the consumer product(s) marketed by the DS structure from their personal and professional contacts.

Many members of DS structures come to exist for a period of time only, and increasing the lifespan of a DS structure becomes difficult without realizing new member recruits making monthly consumer product purchases. These members may discontinue or dishonor obligations incidental to their membership in the DS structure, such as membership fees or obligations to purchase DS products. These problems inherent in traditional DS structures have caused DS structures to suffer low member retention rates, inefficient new member recruitment drives, and unproductive solicitation of new sales from member contacts.

Time has shown that the most effective new members in DS structures are the personal and professional contacts of current members. All parties benefit from the recruitment of these individuals into the DS structure, the older member, the DS structure itself, and the new members. A constant flow of new members who are personally acquainted with old members revitalized the DS structure; but, for the reasons expanded upon above, it can be difficult to incentivize members to invest the effort continually to accomplish this.

Furthermore, the presentation given to prospective members is static and uniform across prospective members of all income levels and all relationship types to the DS member. Current DS companies do not personalize presentations to the DS members.

What is needed in the art is a method shifting solicitation responsibilities from older members, who have traditionally been pushed to assume those responsibilities, to committed individuals trained in sales techniques working under the supervision of the DS structure itself. A method of incentivizing DS members to help with this transition and a means of trading future financial compensation for itemized personal information from a member's about their contacts is needed in the art.

### SUMMARY OF THE INVENTION

From the foregoing discussion, it should be apparent that a need exists for a method of amassing third-party contact information from direct marketing members. The present invention has been developed in response to the present state of the art; and, in particular, in response to the problems and needs in the art that have not yet been fully solved by currently available methods, systems and apparatus, and that overcome many or all of the above-discussed shortcomings in the art. Accordingly, the present invention has been developed to provide a method for amassing third-party contact information from direct marketing members. A method is disclosed of amassing contact information and company valuation estimates of prospective direct sales (DS) members, wherein the prospective DS members are personally acquainted with a current DS member, the steps of the method comprising: incorporating a member into a hierarchal DS structure such that the member is positioned to be remunerated by the DS structure in the form of commissions on sales realized from additional members joining the DS structure after the member is incorporated; and requiring the DS member to provide a list of personal contacts as a condition of continued incorporation, the list comprising one or more of the names, telephone numbers, email addresses, income, religious affiliation, health, age, gender, native language, and mailing addresses (collectively the “contact information”) of one or more of family members, friends, coworkers, acquaintances, and neighbors (collectively the “personal contacts”).

In the method, the list further comprises a numerical valuation estimate exclusively associated with each personal contact, the valuation estimate for each person contact comprising a value representative of the strength of the DS member's belief that the personal contact will form a good DS member in the future; storing data in the list in a database; generating a standardized valuation identifier for each personal contact by standardizing each valuation estimate; plotting the standardized valuation identifiers as a bell curve on graph; digitally contacting each personal contact via one or more of email, text message, and facsimile with a message seemingly from the DS member informing the personal contact of imminent future contact by an DS employee; systematically initiating telephonic contact with the personal contacts in sequence beginning with those contacts at the high end of the bell curve progressing to those at the low end by an DS employee; soliciting the personal contacts to join the DS structure; incorporating one or more of the personal contact(s) into the hierarchal DS structure in a downline of the member, wherein the personal contact(s) are remunerated by the DS structure in the form of commissions on sales realized to additional members joining the DS structure after the personal contact(s) are incorporated; generating a unique productivity value for the DS member in response to the number of personal contacts joining the DS structure; and directly associating the DS member's downline commissions with the unique productivity value.

The method may further comprise paying residual commissions to the DS employee responsible for initiating telephonic contact with the personal contact who incorporated.

The method may further comprise creating a DS compensation criteria with both the DS member and DS employee in the same upline revenue stream.

A computer program product is also disclosed comprising a computer readable medium having computer usable program code executable to perform operations for amassing contact information for commonly acquainted DS prospects, the operations of the computer program product comprising: incorporating a member into a hierarchal DS structure such that the member is positioned to be remunerated by the DS structure in the form of commissions on sales realized from additional members joining the DS structure after the member is incorporated; requiring the DS member to provide a list of personal contacts via a web browser as a condition of continued incorporation, the list comprising one or more of the names, telephone numbers, email addresses, income, religious affiliation, health, age, gender, native language, and mailing addresses (collectively the “contact information”) of one or more of family members, friends, coworkers, acquaintances, and neighbors (collectively the “personal contacts”); wherein the list further comprises a numerical valuation estimate exclusively associated with each personal contact, the valuation estimate for each person contact comprising a value representative of the strength of the DS member's belief that the personal contact will form a good DS member in the future; storing data in the list in a database; generating a standardized valuation identifier for each personal contact by standardizing each valuation estimate; plotting the standardized valuation identifiers as a bell curve on graph; systematically initiating contact with the personal contacts in sequence beginning with those contacts at the high end of the bell curve progressing to those at the low end by an DS employee, wherein the contact is seemingly from the DS member; incorporating via a web browser one or more of the personal contact(s) into the hierarchal DS structure in a downline of the member, wherein the personal contact(s) are remunerated by the DS structure in the form of commissions on sales realized to additional members joining the DS structure after the personal contact(s) are incorporated; generating a unique productivity value for the DS member in response to the number of personal contacts joining the DS structure; and directly associating the DS member's downline commissions with the unique productivity value.

In some embodiments, the contact information is stored in a B-tree data structure on a computer readable storage device in contact the with computer program product.

The computer program product may further comprise splicing together multimedia segments exclusively associated with information in the list to form a multimedia presentation personalized for the contact, and showing said multimedia presentation to the contact.

The computer program product may further comprise adding a multimedia segment to a multimedia presentation in response to one or more values in the list satisfying a predetermined criteria.

A method of amassing contact information and company valuation estimates of prospective direct sales (DS) members is disclosed, wherein the prospective DS members are personally acquainted with a current DS member, the steps of the method comprising: requiring the DS member to provide a list of personal contacts as a condition of continued incorporation, the list comprising one or more of the names, telephone numbers, email addresses, income, religious affiliation, health, age, gender, native language, and mailing addresses (collectively the “contact information”) of one or more of family members, friends, coworkers, acquaintances, and neighbors (collectively the “personal contacts”); wherein the list further comprises a numerical valuation estimate exclusively associated with each personal contact, the valuation estimate for each person contact comprising a value representative of the strength of the DS member's belief that the personal contact will form a good DS member in the future; digitally contacting each personal contact via one or more of email, text message, and facsimile with a message seemingly from the DS member informing the personal contact of imminent future contact by an DS employee; systematically initiating telephonic contact with the personal contacts in sequence beginning with those contacts at the high end of the bell curve progressing to those at the low end by an DS employee; incorporating one or more of the personal contact(s) into the hierarchal DS structure in a downline of the member, wherein the personal contact(s) are remunerated by the DS structure in the form of commissions on sales realized to additional members joining the DS structure after the personal contact(s) are incorporated; and compensating the DS member a commission for each contact who incorporated into the DS structure.

The computer program product may further comprise systematically mailing post cards to each contact on the list, or systematically mailing letters to each contact on the list.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an entity-relationship diagram illustrating the relationship between entities in an DS structure working together to amass third-party contact information of commonly acquainted prospects into a direct sales structure in accordance with the present invention;

FIG. 1B is modularized representation of a list in accordance with the present invention;

FIG. 1C is an entity-relationship diagram illustrating the steps of a method for amassing contact information in accordance with the present invention;

FIG. 2 is a block diagram illustrating the relationship between commission tiers and remuneration to members and employees of an DS structure incorporated by amassing contact information of commonly acquainted prospects in accordance with the present invention;

FIG. 3 is a process flow chart of a method of amassing contact information of commonly acquainted prospects into a direct sales structure in accordance with the present invention;

FIG. 4 is a second process flow chart of a method of amassing contact information of commonly acquainted prospects into a direct sales structure in accordance with the present invention; and

FIG. 5 is an entity-relationship diagram illustrating another embodiment of a system for performing operations for amassing contact information of commonly acquainted prospects into a direct sales structure in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

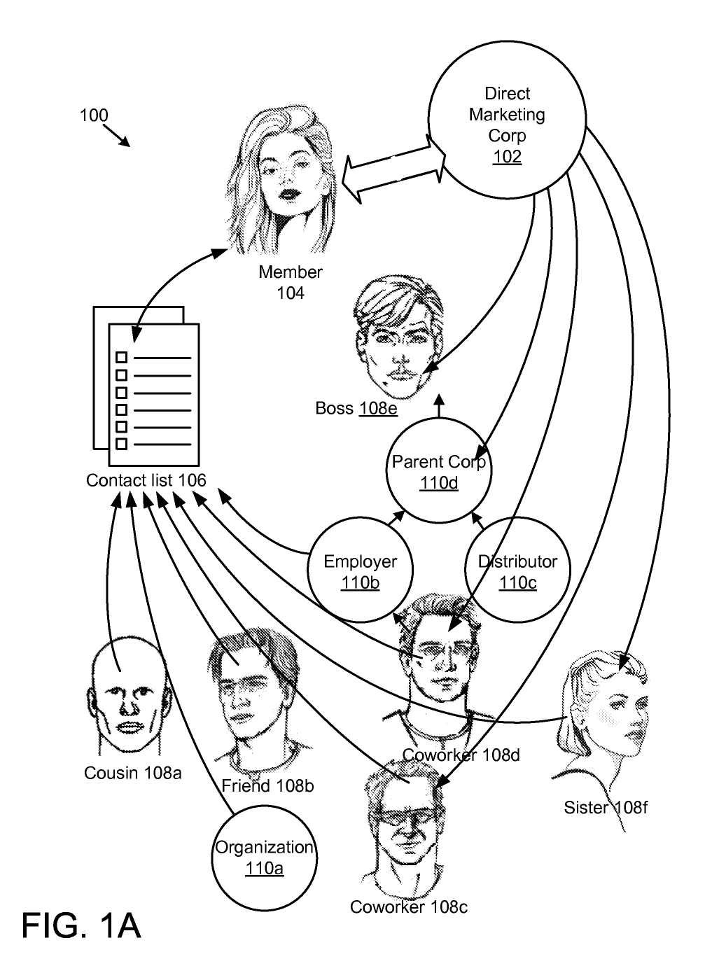

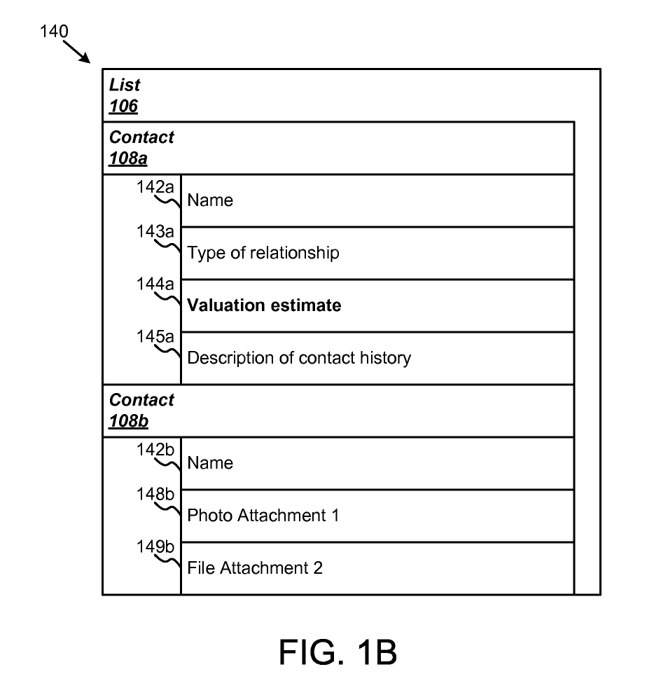

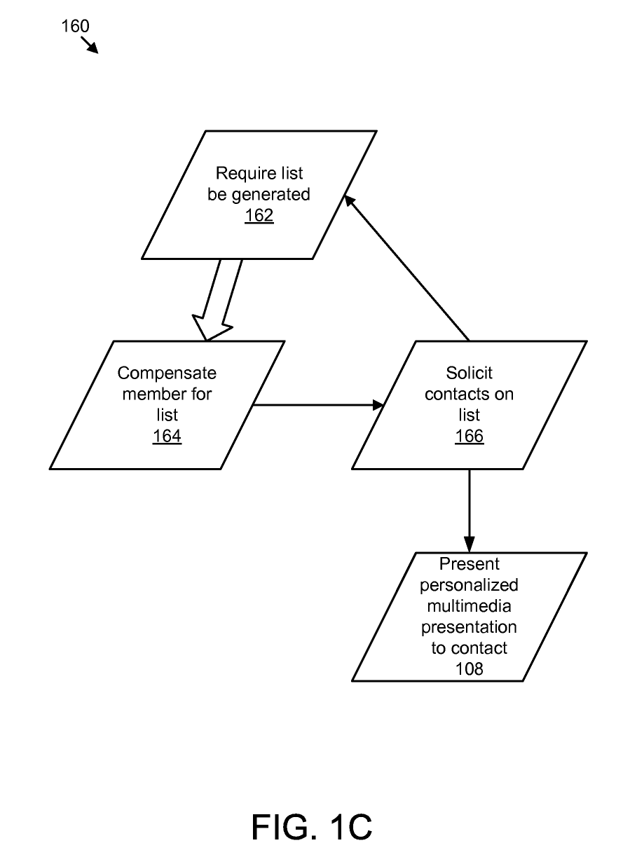

FIG. 1 is an entity-relationship diagram illustrating the relationship between entities in a DS structure working together to amass third-party contact information of commonly acquainted prospects into a direct sales structure in accordance with the present invention. The entity-relationship 100 comprises a direct marketing corporation (i.e. DS corporation) 102, a DS member 104, a contact list 106, individuals 108a-f, and corporation 110a-c.

Each of the entities in the relationship 100 form part of a DS structure, which markets a consumer product, service or business opportunity. The consumer product may comprise any valuable item which can be purchased, tangible or intangible. Examples of consumer products may include fruit drinks, vitamins, cleaners, cars, computers, tools, and the like. The consumer product may be intangible, and/or comprise video, audio, digit text files, or the like.

For the purposes of this patent, the term “DS structure” or “DS” denotes a direct sales business structure that incorporates its members in hierarchical pay grades, or levels, and remunerates commissions to members in higher levels for the sales of consumer products realized by members in lower levels whom have been incorporated into the DS structure as a result of the efforts of members in the higher levels. DS structures are well-known to those of skill in the art.

The members 104 may comprise any person, company or organization that is potentially a customer of another person, company or organization. The member 104 may purchase one or more consumer products and become “incorporated” into the DS structure, or the member 104 may purchase the consumer product and not become incorporated. For the purposes of this patent, the terms “incorporate” and “incorporation” denote the act of formally enrolling an individual or organization into an DS structure such that the individual or organization receives commissions on downline sales (sales realized as a result of the efforts of contacts of the individual or organization which are later incorporated), through a mutually recognized business relationship with the DS structure.

It is the object of the present invention to protect a process of:
(a) Paying DS members 104 to provide a list 106 of personal and professional contacts 108, and the contact information of those contacts 108, the list uploaded into computer readable memory;
(b) Soliciting contacts 108 provided in the list 106 with a two fold approach: (i) first, directly soliciting each contact 108 via electronic communication (e.g. email, SMS message, and the like), and (ii) requiring, or prompting electronically, a human being to initiate personal contact with the contact 108; and
(c) Directing, in the electronic and personal communication (using hyperlinks, QR codes, and the like) the contact 108 to a URL on the Internet resolving to a personalized graphic multimedia presentation created in response to computer readable information in the list, which streams over the Internet to the contact's 108 computer or DPD.

Using the steps of this method, the present invention teaches more efficient means of bringing DS members into a DS structure and converting contacts 108, 110 into members 104, after which time the process repeats.

Contact may be initiated with contacts 108 using any or all of many different methods, each realized by automated computer-run processes, including mailing electronic communications, printing direct mail pieces such as post cards or letters, or initiating telephonic communication reliant in whole or in part on IVR systems. Human solicitors may also initiate contact with the contacts 108.

Like the member 104, the prospective member 108a-f may comprise any person, company or organization that is potentially a customer of another person, company or organization. The prospective members 108a-f may purchase one or more consumer products and become “incorporated” into the DS structure, or the prospective members 106a-f may purchase the consumer product and not become incorporated.

The contact list 106, in this embodiment, comprises information about the prospective members 108a-f with whom the member 104 associates personally or professionally. The contact information may comprise information about individuals and organizations not associated with the member 104. The contact information may include one or more of: age, address, gender, credit rating, email, telephone number, income, education, and purchasing practices. In some embodiments, the contact information is written down by the member 104 and transferred to the solicitor 108 on a printed medium or using programs well-known to those of skill in the art, such Microsoft Outlook, Thunderbird, Yahoo! Mail, and the like.

The personal contacts of the member 104a are solicited by the solicitor telephonically. In various embodiments, as further described below, a personalized multimedia presentation is displayed to a contact 108 responded to electronic solicitation from the solicitor. This multimedia presentation may contain an invitation to the contact 108 to attend a meeting, seminar, conference, or recruitment drive sponsored or hosted by the DS company.

In some embodiments, the DS structure may automatically make commission payments to members incorporated into the DS structure via means well-known to those of skill in the art, including PayPal®, credit card credits, direct bank deposits, and the like. Commission payments to members may be made in accordance with a predetermined DS criteria. In some embodiments, the predetermined DS criteria is dynamic, and optimized automatically through analysis of historical DS sales data to maximize profits to the DS structure and/or DS members.

FIG. 1B is modularized representation of a list 100 in accordance with the present invention. The list 106 comprises information identifying contacts 108a-b. This information comprises names 142a-b, a type of relationship 143a, a valuation estimate 144a, a description of contact history 145a, a picture 148b of the contact 108b, and a file attachment 149b.

In the present embodiment, the contact list 106 comprises valuation estimates 144 of the DS member 104. These valuation estimates 144 comprise numerical values assigned by the DS member 104 to the personal contacts 108 (i.e. prospective members 108) identified by the contact list 106 representing the DS member's 104 own assessment of the likelihood that the personal contact 108 exclusively associated with the valuation estimate will become a commercially viable member 104 of the DS structure 102.

The list 106 may comprise pictures 148 or attachments 149 that contain information relevant to soliciting the contact 108 into the DS company. Because contacts 110 may be corporations, and members 104 are compensated on commission, members 104 may be motivated to provide many different types of pictures, video, or multimedia to a company 102 solicitor.

FIG. 1C is an entity-relationship diagram illustrating the steps of a method 160 for amassing contact information in accordance with the present invention. Fundamentally, the steps of the method disclosed circles around these four shown steps further described above and below: (1) requiring a member 104 to provide a list 106; (2) compensating the member 104 for revenue generated from this list 106; and (3) soliciting these contacts 108 using, in part, a multimedia presentation.

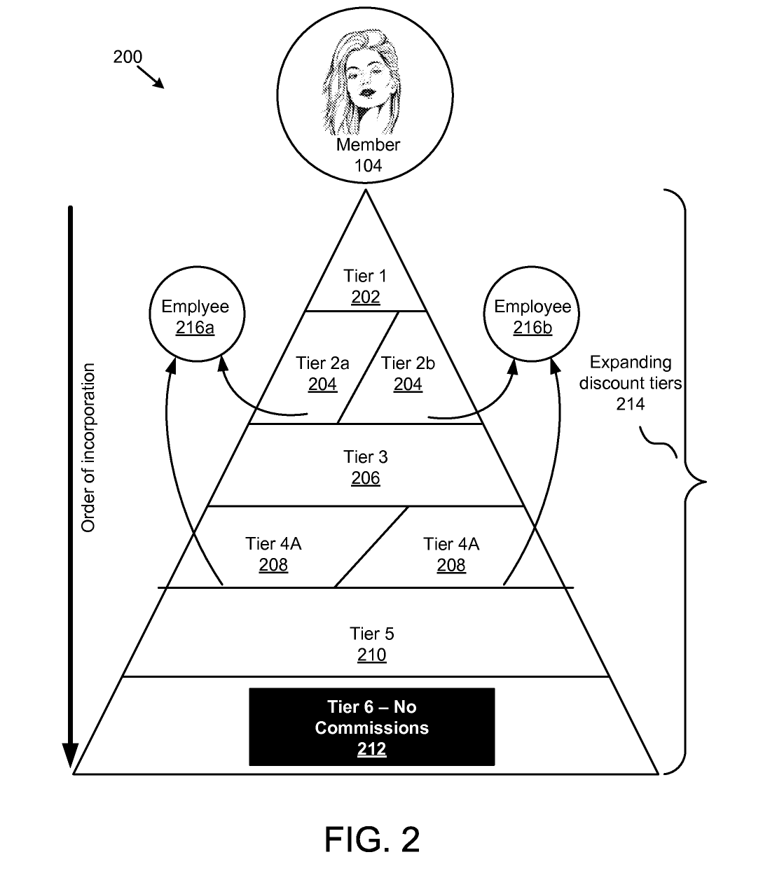

FIG. 2 is a block diagram illustrating the relationship 200 between commission tiers and remuneration to members and employees of a DS structure incorporated by amassing contact information of commonly acquainted prospects in accordance with the present invention.

The system 100 includes an employee 212. The employee 212 may consist of an individual or comprise a DPD, a company or organization which solicits prospects 108, an individual, or any combination of the above. In the shown embodiment, the employee 212 comprises a DPD controlled by a DS structure interested in soliciting potential DS members and/or prospects 108.

In some embodiments, the employee 212 is configured to interact with a prospect 108 through a web browser, graphical user interface (GUI) coupled to a DPD or the maintenance server 102. The solicitor 108 is configured to retrieve and/or receive the contact information 116 from, or through, the maintenance server 102. In some embodiments, the solicitor 108 may be configured to receive the contact information 116 as an email attachment using variations of the Simple Mail Transfer Protocol (SMTP) FTP, Internet Message Access Protocol (IMAP), Post Office Protocol (POP), or other protocols well-known to those of skill in the art.

The employee 212, in some embodiments, may comprise a computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

In the shown embodiment, the employee 212 electronically with the member 104a using variations of the Simple Mail Transfer Protocol (SMTP), Internet Message Access Protocol (IMAP), Post Office Protocol (POP), or other protocols well-known to those of skill in the art.

Prospects 108 incorporated by the employee 212 join a tier of the commission structure 200 with residual commissions flowing upward toward the member 104 ultimately responsible for identifying those subsequent prospects and their prospects into the DS structure.

The member 104 is compensated not just for revenue realized on contacts 108, 110, but also on revenue realized from the contacts those contacts 108 later bring into the DS company, and so on.

In various embodiments, the solicitors or employees of the DS company derive revenue from tiers, levels, or generations, in the member's 104 downline.

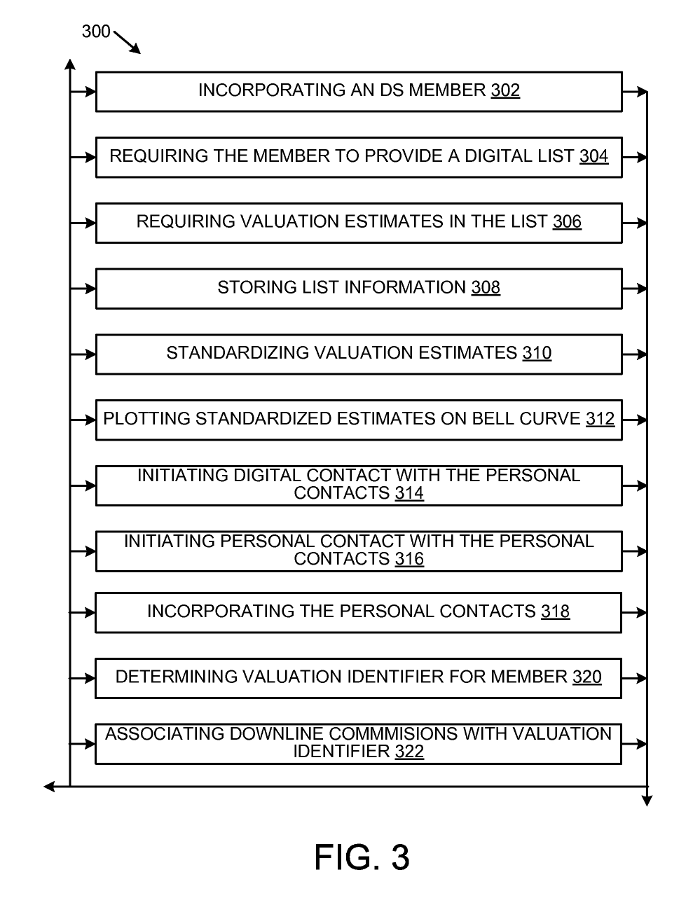

FIG. 3 is a process flow chart of a method 300 of amassing contact information of commonly acquainted prospects into a direct sales structure in accordance with the present invention.

The method 300 proceeds as shown. A contact 108, 110 is incorporated 302 into the DS structure, and required, in accordance with the present invention to provide a list 106 of personal and professional contacts 108, and the contact information of those contacts 108, the list uploaded into computer readable memory. This information may comprise name, address, email, telephone number, mailing address, income information, and a valuation rating of the member 104 uploading the list 106 comprising this information.

The member 104, in some embodiments, is required to rank the contacts 108 identified in the list 106 in order of most likely to be responsive to solicitation by the DS company 102. In other embodiments, the member 104 is required to assign a numeric valuation rating to each contact 108.

List 106 information is stored 308 in database form, and used to standardize the valuation estimates provided by the member 104. The contacts 108 are solicited directly via electronic communication (e.g. email, SMS message, and the like), and by requiring, or prompting electronically, a human being to initiate personal contact with the contact 108.

Electronic and personal communication (using hyperlinks, QR codes, and the like) is directed to the contact 108 to a URL on the Internet resolving to a personalized graphic multimedia presentation created in response to computer readable information in the list, which streams over the Internet to the contact's 108 computer or DPD.

Information provided in the list 106 may be passed as parameters in computer function or class to determine if the information satisfies predetermined criteria. If the information satisfies a predetermined criterion, multimedia segments a spliced by computer into the multimedia presentation, which is shown to the contact 108.

Using the steps of this method, the present invention teaches more efficient means of bringing DS members into a DS structure and converting contacts 108, 110 into members 104, after which time the process repeats.

After contacts 108 are incorporated into the DS company, a valuation identifier is assigned is exclusively associated with each contact 108 who incorporated with the DS company.

Members 104 of the DS company may be compensated a flat fee for generating the list 106, and/or may be compensated a flat fee for each contact 108 identified in the list 106, and/or may be compensated a flat fee for the amount of information the member 104 provides about each contact 108 in the list 106.

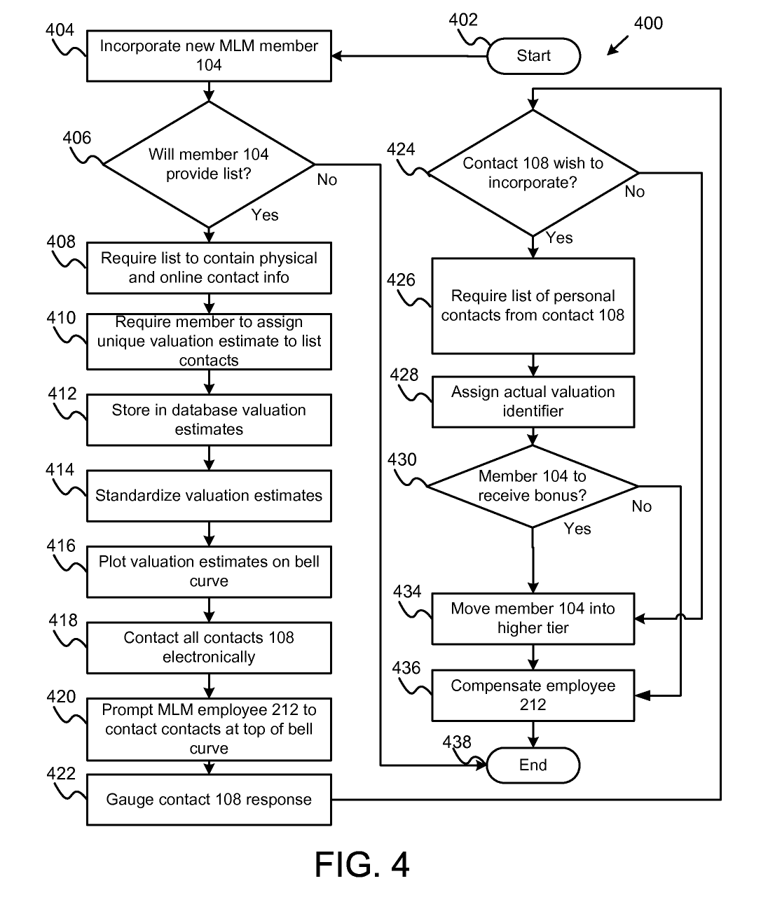

FIG. 4 is a second process flow chart of a method of amassing contact information of commonly acquainted prospects into a direct sales structure in accordance with the present invention.

In various embodiments of the present invention, the contacts 108 are contacted 418 electronically and referred to a multimedia presentation on the Internet using a hyperlink or QR code.

The presentation is personalized for the contact 108 who is viewing it. The presentation, in some embodiments, incorporated the contact's 108 name into text in the presentation. A computer in logical connection with the computer readable storage storing the database inserts text and/or video into the presentation in response to identifying a type of relationship the contact 108 has with the member 104, with a different text or video insert for a brother, sister, wife, friend, neighbor, coworker, co-parishioner, and the like.

In various other embodiments, different sections of text and/or video are inserted into, or removed from, the multimedia presentation in response to the computer determining the contact 108 is in a certain income level or whose valuation estimate exceeds a predetermined threshold on the bell curve.

As mentioned above, contact may be realized by automated computer-run processes, including mailing electronic communications, printing direct mail pieces such as post cards or letters, or initiating telephonic communication reliant in whole or in part on IVR systems.

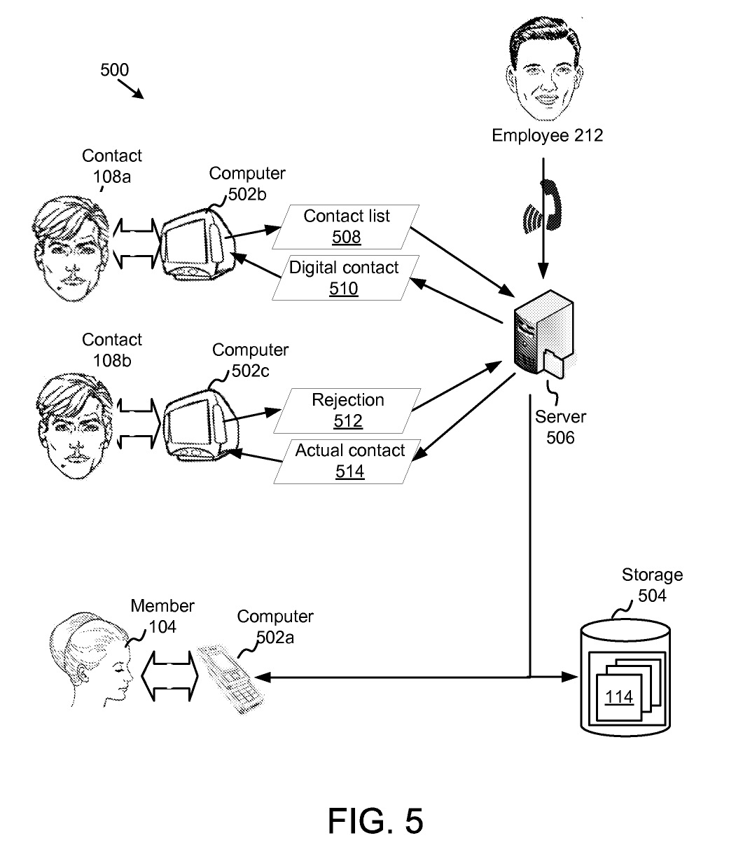

FIG. 5 is an entity-relationship diagram illustrating another embodiment of a system for performing operations for amassing contact information of commonly acquainted prospects into a direct sales structure in accordance with the present invention.

The member 104 may upload the list 106 via a computer 502a into computer readable storage 504. Digital contact 510 is initiated by the server 506 with contact 108a and 108b. Contact 108b rejects the electronic contact 510 and is struck from the list 106. Contact 108a accepts the electronic contact and provides a second list 106. In various embodiments, contacts 108 may provide lists 106 without incorporating into the DS company.

The electronic communication sent to each prospective member 108 may contain an invitation to the contact 108 that he/she attend a meeting hosted or sponsored by the DS company for recruiting new DS members 104 into the DS company.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of amassing contact information and company valuation estimates of prospective direct sales (DS) members, wherein the prospective DS members are personally acquainted with a current DS member, the steps of the method comprising:
incorporating a member into a hierarchal DS structure such that the member is positioned to be remunerated by the DS structure in the form of commissions on sales realized from additional members joining the DS structure after the member is incorporated;
requiring the DS member to provide a list of personal contacts as a condition of continued incorporation, the list comprising one or more of the names, telephone numbers, email addresses, income, religious affiliation, health, age, gender, native language, and mailing addresses (collectively the “contact information”) of one or more of family members, friends, coworkers, acquaintances, and neighbors (collectively the “personal contacts”); wherein the list further comprises a numerical valuation estimate exclusively associated with each personal contact, the valuation estimate for each person contact comprising a value representative of the strength of the DS member's belief that the personal contact will form a good DS member in the future;
storing data in the list in a database;
generating a standardized valuation identifier for each personal contact by standardizing each valuation estimate;
plotting the standardized valuation identifiers as a bell curve on graph;
digitally contacting each personal contact via one or more of email, text message, and facsimile with a message seemingly from the DS member informing the personal contact of imminent future contact by an DS employee;
systematically initiating telephonic contact with the personal contacts in sequence beginning with those contacts at the high end of the bell curve progressing to those at the low end by an DS employee;
soliciting the personal contacts to join the DS structure;
incorporating one or more of the personal contact(s) into the hierarchal DS structure in a downline of the member, wherein the personal contact(s) are remunerated by the DS structure in the form of commissions on sales realized to additional members joining the DS structure after the personal contact(s) are incorporated;
generating a unique productivity value for the DS member in response to the number of personal contacts joining the DS structure; and
directly associating the DS member's downline commissions with the unique productivity value.

2. The method of claim 1, further comprising paying residual commissions to the DS employee responsible for initiating telephonic contact with the personal contact who incorporated.

3. The method of claim 2, further comprising creating a DS compensation criteria with both the DS member and DS employee in the same upline revenue stream.

4. The method of claim 3, further comprising remunerating to the DS member a flat fee amount for creating the list.

5. The method of claim 3, further comprising remunerating to the DS member a flat fee amount for each contact identified in the list.

6. The method of claim 3, further comprising remunerating to the DS member fees on a graduated scale for the amount of information provided about each contact identified in the list.

7. A computer program product comprising a computer readable medium having computer usable program code executable to perform operations for amassing contact information for commonly acquainted DS prospects, the operations of the computer program product comprising:
incorporating a member into a hierarchal DS structure such that the member is positioned to be remunerated by the DS structure in the form of commissions on sales realized from additional members joining the DS structure after the member is incorporated;
requiring the DS member to provide a list of personal contacts via a web browser as a condition of continued incorporation, the list comprising one or more of the names, telephone numbers, email addresses, income, religious affiliation, health, age, gender, native language, and mailing addresses (collectively the “contact information”) of one or more of family members, friends, coworkers, acquaintances, and neighbors (collectively the “personal contacts”); wherein the list further comprises a numerical valuation estimate exclusively associated with each personal contact, the valuation estimate for each person contact comprising a value representative of the strength of the DS member's belief that the personal contact will form a good DS member in the future;
storing data in the list in a database;
generating a standardized valuation identifier for each personal contact by standardizing each valuation estimate;
plotting the standardized valuation identifiers as a bell curve on graph;
systematically initiating contact with the personal contacts in sequence beginning with those contacts at the high end of the bell curve progressing to those at the low end by an DS employee, wherein the contact is seemingly from the DS member;
incorporating via a web browser one or more of the personal contact(s) into the hierarchal DS structure in a downline of the member, wherein the personal contact(s) are remunerated by the DS structure in the form of commissions on sales realized to additional members joining the DS structure after the personal contact(s) are incorporated;
generating a unique productivity value for the DS member in response to the number of personal contacts joining the DS structure; and
directly associating the DS member's downline commissions with the unique productivity value.

8. The computer program product of claim 7, wherein the contact information is stored in a B-tree data structure on a computer readable storage device in contact the with computer program product.

9. The computer program product of claim 7, further comprising splicing together multimedia segments exclusively associated with information in the list to form a multimedia presentation personalized for the contact, and showing said multimedia presentation to the contact.

10. The computer program product of claim 7, further comprising adding a multimedia segment to a multimedia presentation in response to one or more values in the list satisfying a predetermined criteria.

11. A method of amassing contact information and company valuation estimates of prospective direct sales (DS) members, wherein the prospective DS members are personally acquainted with a current DS member, the steps of the method comprising:
requiring the DS member to provide a list of personal contacts as a condition of continued incorporation, the list comprising one or more of the names, telephone numbers, email addresses, income, religious affiliation, health, age, gender, native language, and mailing addresses (collectively the “contact information”) of one or more of family members, friends, coworkers, acquaintances, and neighbors (collectively the “personal contacts”); wherein the list further comprises a numerical valuation estimate exclusively associated with each personal contact, the valuation estimate for each person contact comprising a value representative of the strength of the DS member's belief that the personal contact will form a good DS member in the future;
digitally contacting each personal contact via one or more of email, text message, and facsimile with a message seemingly from the DS member informing the personal contact of imminent future contact by an DS employee;
systematically initiating telephonic contact with the personal contacts in sequence beginning with those contacts at the high end of the bell curve progressing to those at the low end by an DS employee;
incorporating one or more of the personal contact(s) into the hierarchal DS structure in a downline of the member, wherein the personal contact(s) are remunerated by the DS structure in the form of commissions on sales realized to additional members joining the DS structure after the personal contact(s) are incorporated; and
compensating the DS member a commission for each contact who incorporated into the DS structure.

12. The computer program product of claim 11, further systematically mailing post cards to each contact on the list.

13. The computer program product of claim 11, further systematically mailing letters to each contact on the list.
